(19) United States
(12) Patent Application Publication
(10) Pub. No.: US 2014/0228000 A1
(43) Pub. Date: Aug. 14, 2014

(54) TERMINAL DEVICE, INFORMATION PROCESSING APPARATUS AND ACTIVATION AUTHENTICATION METHOD

(71) Applicant: Fujitsu Limited, Kawasaki-shi (JP)

(72) Inventors: Hideyuki NAGATOSHI, Kawasaki (JP); Masaki MUKOUCHI, Machida (JP); Jun SOMEKAWA, Yokosuka (JP); Teruki KOJIMA, Inagi (JP)

(73) Assignee: FUJITSU LIMITED, Kawasaki-shi (JP)

(21) Appl. No.: 14/161,162

(22) Filed: Jan. 22, 2014

(30) Foreign Application Priority Data
Feb. 8, 2013 (JP) 2013-023586

(51) Int. Cl. H04W 12/08

(52) U.S. Cl. CPC H04W 12/08
USPC 455/411

(57) ABSTRACT

There is provided a terminal device which includes: a storage unit configured to store an activation determination condition; and a control unit configured to execute a procedure, including: acquiring first position information for indicating an area where the terminal device is located; authenticating an activation based on the activation determination condition stored in the storage unit and the first position information; and inquiring of an information processing apparatus coupled through a communication network as to whether activation is allowable when an authentication result of the authenticating of activation is an activation forbiddance.

### CROSS-REFERENCE TO RELATED APPLICATION

This application is based upon and claims the benefit of priority from the prior Japanese Patent Application No. 2013-023586 filed on Feb. 8, 2013, the entire contents of which are incorporated herein by reference.

### FIELD

The present disclosure relates to a terminal device, an information processing apparatus and an activation authentication method.

### BACKGROUND

There has been a method which prevents a terminal device such as a personal computer (PC) used by a user from being illegally used when lost or stolen and a method which permits the terminal device to be used only at a specific authorized place.

For example, there is a method in which the user terminal transmits position information to a management server and the management server determines whether the user terminal is available. See, for example, Japanese Patent Application Laid-Open No. 2008-250627.

### SUMMARY

According to one aspect of the embodiments, there is provided a terminal device which includes: a storage unit configured to store an activation determination condition; and a control unit configured to execute a procedure, including: acquiring first position information for indicating an area where the terminal device is located; authenticating an activation based on the activation determination condition stored in the storage unit and the first position information; and inquiring of an information processing apparatus coupled through a communication network as to whether activation is allowable when an authentication result of the authenticating of activation is an activation forbiddance.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating an example of a schematic configuration of an activation authentication system;

FIG. 2 is a view illustrating an example of a functional configuration of a user terminal according to the present embodiment;

FIG. 3 is a view illustrating an example of a hardware configuration in which an activation authentication process may be implemented according to the present embodiment;

FIG. 4 is a view illustrating an example of a functional configuration of an information processing apparatus according to the present embodiment;

FIG. 5 is a flowchart illustrating a first embodiment of the activation authentication process in the user terminal;

FIG. 6 is a flowchart illustrating a first embodiment of the activation authentication process in a management server;

FIG. 7A and FIG. 7B are views illustrating an example of data associated with the first embodiment;

FIG. 8 is a flowchart illustrating a second embodiment of the activation authentication process in the user terminal;

FIG. 9 is a flowchart illustrating a second embodiment of the activation authentication process in the management server;

FIG. 10A and FIG. 10B are views illustrating an example of data associated with the second embodiment;

FIG. 11 is a flowchart illustrating a third embodiment of the activation authentication process in the user terminal;

FIG. 12 is a flowchart illustrating a third embodiment of the activation authentication process in the management server;

FIG. 13A and FIG. 13B are views illustrating an example of data associated with the third embodiment;

FIG. 14 is a flowchart illustrating a fourth embodiment of the activation authentication process in the user terminal;

FIG. 15 is a flowchart illustrating a fourth embodiment of the activation authentication process in the management server; and

FIG. 16A and FIG. 16B are views illustrating an example of data associated with the fourth embodiment.

### DESCRIPTION OF EMBODIMENTS

A method in which the user terminal transmits position information to a management server and the management server determines whether the user terminal is available requires transmitting the position information of, for example, a PC, to the management server each time when the PC is activated to obtain authentication from the management server. Therefore, the PC is required to communicate with the management server at the time of the PC activation even at a place within which the PC is authenticated once already and thus, communication traffic is increased.

Hereinbelow, a technology in which an activation authentication may be executed without increasing the communication traffic will be described with reference to accompanying drawings.

### <Example of Schematic Configuration of Activation Authentication System>

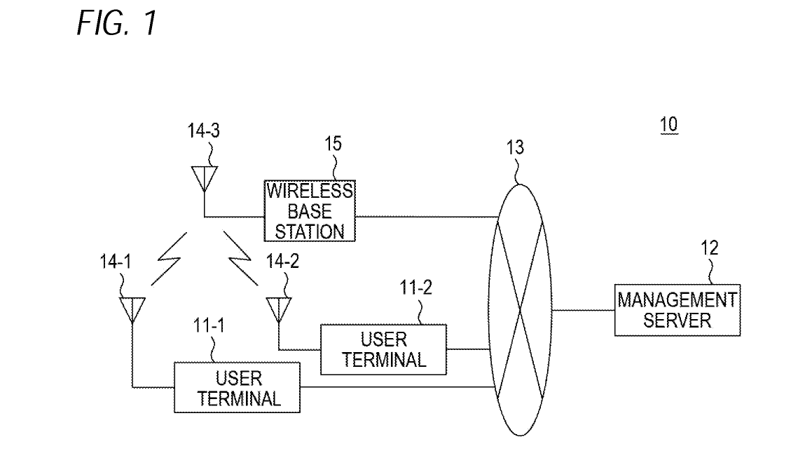

FIG. 1 is a view illustrating an example of a schematic configuration of an activation authentication system. An activation authentication system 10 illustrated in FIG. 1 generally includes user terminals 11-1, 11-2 as an example of a terminal device and a management server 12 as an example of an information processing apparatus. Further, the user terminal 11 and the management server 12 are connected with each other in a state where data can be transmitted and received therebetween through the communication network 13.

Further, the user terminals 11-1 and 11-2 may each include the antenna units 14-1 and 14-2, respectively, and communicate with the antenna unit 14-3 installed in the wireless base station 15. In the meantime, the management server 12 of the activation authentication system 10 illustrated in FIG. 1 manages two user terminals 11-1, 11-2, but is not limited thereto. For example, one or plural user terminals may be managed by the management server 12. In the following description, the user terminals 11-1, 11-2 and the antenna units 14-1, 14-2 may be collectively referred to as “user terminal 11” and “antenna unit 14” as needed, respectively.

The user terminal 11 is a terminal used by the user and may be, for example, a portable terminal device which is movable or a fixed type terminal device. In the present embodiment, for example, when the user terminal 11 is stolen, even the fixed terminal device may likely be used at other places.

For example, when it is detected that the power supply is turned ON by the user, the user terminal 11 performs the activation authentication based on a predetermined activation determination condition. Specifically, the user terminal 11 acquires the position information of an area where the user terminal is located, and performs the activation authentication based on the position information and the activation determination condition stored in the storage unit in advance. When the activation is permitted, the user terminal 11 may activate, for example, an Operating System (OS) installed in the user terminal 11.

Further, when an authentication result indicates that the activation of the user terminal 11 is not allowed (activation forbiddance), the user terminal 11 inquires the management server 12 as to whether the activation is allowable. Inquiry to the management server 11 as to whether the activation is allowable may be made through the wireless base station 15, otherwise the inquiry may be made directly through the communication network 13. Further, when the activation permission is obtained from the management server 12, the user terminal 11 may activate, for example, the OS. In the meantime, when the activation permission is obtained from the management server 12, the user terminal 11 stores the activation determination condition obtained from the management server 12 in the storage unit. Accordingly, in a case where the user terminal 11 performs the activation authentication on or after the next time, the user terminal 11 may use the activation determination condition stored in the storage unit to perform the activation authentication without accessing the management server 12.

In the meantime, when the activation permission is not obtained (activation forbiddance) from the management server 12, the user terminal 11 may not be activated at the place where the user terminal 11 is located and the power supply thereof is turned OFF. In this case, an authentication error message may be displayed on a screen of the user terminal 11.

Here, a position information acquisition method in the user terminal 11 may use a wireless communication (for example, notification information) from, for example, the wireless base station 15 in a Personal Handy-phone System (PHS). Further, the position information acquisition method is not limited thereto, but may acquire the position information using a Global Positioning System (GPS) function by installing the GPS function in, for example, the user terminal 11. Further, the position information acquisition method may acquire the position information using, for example, an Internet Protocol (IP) address or the position information using the position information of a Wi-Fi (registered trademark) base station.

As for the user terminal 11, a PC or a notebook PC may be used, but the user terminal 11 is not limited thereto, and may include, for example, a portable phone terminal such as a smart phone, a portable phone or a tablet terminal, a gaming equipment, or a music playback apparatus.

The management server 12 is an information processing apparatus which manages whether activation of one or plural user terminals 11 connectable through the communication network 13 is allowable. Specifically, the management server 12 stores the activation determination condition for determining whether activation is allowable for each user terminal 11 set by a manager.

Further, in a case where there is an inquiry of whether the activation is allowable based on the position information from the user terminal 11, the management server 12 collates the position information with the activation determination condition set in advance. Based on the collation result, the management server 12 transmits a determination result of whether the activation is allowable to the user terminal 11 which made an inquiry of whether the activation is allowable. Further, the management server 12 generates the activation determination condition to be stored in the storage unit of the user terminal 11 when permitting activation of the user terminal 11, and transmits the generated activation determination condition to the user terminal 11 which made an inquiry of whether the activation is allowable.

A general purpose PC or a server apparatus, or a cloud server may be used as the management server 12.

The communication network 13 includes a network topology represented by, for example, the Internet or a Local Area Network (LAN), but is not limited thereto.

The antenna unit 14 is a device which transmits/receives data wirelessly between the user terminal 11 and the wireless base station 15.

The wireless base station 15 performs data communication with the user terminal 11. Further, the wireless base station 15 regularly transmits the position information of the wireless base station 15 to the user terminal 11. Specifically, when the power supply of the user terminal 11 is turned ON to be activated, the user terminal 11 receives notification information transmitted regularly from the antenna unit 14-3 of the nearest wireless base station 15, and acquires the position information included in the received notification information. Also, the user terminal 11 transmits a unique identification information from the antenna unit 14 to the wireless base station 15 to request the wireless base station 15 to register the position of the user terminal 11. The wireless base station 15 acquires individual identification information of the user terminal 11 described above from the antenna unit 14-3, and performs the position registration of the user terminal. Accordingly, the wireless base station 15 may grasp approximate positions of all of the user terminals 11.

As described above, the activation determination condition information is stored in the user terminal 11 in the present embodiment. Therefore, if the user terminal is located at the same area as that at the previous time of activation even at the next time of activation, the user terminal 11 may determine itself to be activated and thus, an efficient permission authentication may be implemented. Further, a frequent communication with the management server 12 is not needed at the time of activation according to the present embodiment. Therefore, the communication traffic may be reduced in the present embodiment.

Subsequently, the user terminal 11 and the management server 12 in the activation authentication system 10 described above will be described in detail.

<Example of Functional Configuration of User terminal 11>

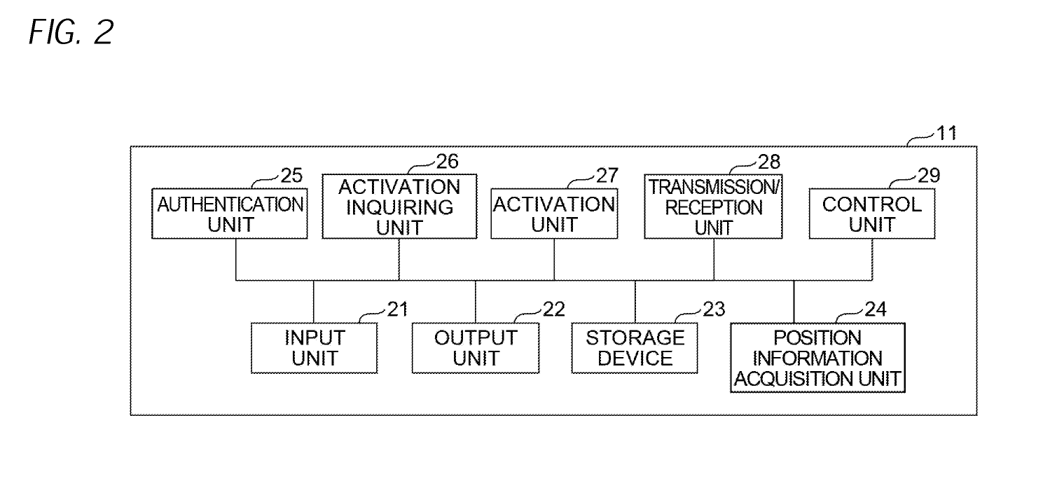

FIG. 2 is a view illustrating an example of a functional configuration of a user terminal according to the present embodiment. The user terminal 11 illustrated in FIG. 2 includes an input unit 21, an output unit 22, a storage unit 23, a position information acquisition unit 24, an authentication unit 25, an activation inquiring unit 26 for inquiring whether activation is allowable, an activation unit 27, a transmission/reception unit 28, and a control unit 29.

The input unit 21 receives various inputs such as for example, start/end of various instructions, and settings from the user through the user terminal 11. Specifically, the input unit 21 receives various instructions such as for example, position information acquisition instruction, authentication instruction, inquiry of whether activation is allowable, activation instruction, and transmission/reception instruction in the present embodiment.

Information acquired by the input unit 21 may be input by an input interface such as the keyboard or the mouse, touch panel type input using a monitor screen, or input using a manipulation key. Further, the input unit 21 may include a voice input unit in which voice is input by, for example, a microphone.

The output unit 22 outputs contents acquired by the input unit 21 and a result performed based on the acquired contents. In the meantime, the output unit 22 may include a displaying unit such as for example, a display or a monitor when outputting by displaying on the screen, or include a voice outputting unit such as for example, a speaker when outputting with voice. Further, the input unit 21 and the output unit 22 may be an integral type input/output unit such as for example, the touch panel.

The storage unit 23 stores various information needed in the present embodiment. Specifically, the storage unit 23 stores various information, such as an activation determination condition table, the position information, an authentication result, an activation history, used for performing the activation permission authentication.

Further, the storage unit 23 may read or write stored information at a predetermined timing as needed. The storage unit 23 is a collection of various types of information described above, and may have a function of a database systematically configured such that the information may be retrieved and extracted using, for example, keyword. In the meantime, the storage unit 23 may be a hard disk or a memory device.

The position information acquisition unit 24 acquires the position information (for example, coordinates, or latitude and longitude) of an area where the user terminal 11 is currently located. Specifically, the position information acquisition unit 24 acquires the position information of the wireless base station 15 (for example, a base station for the PHS or the portable terminal) located nearest to the user terminal 11. Accordingly, the position information that may be acquired using the method described above is the position information of the wireless base station 15, and the user terminal 11 may be located within an electronic wave range of the wireless base station 15.

Further, the position information acquisition unit 24 may acquire the position information of a place where the user terminal 11 is currently located using, for example, the GPS function installed in advance. Further, the position information acquisition unit 24 may acquire an approximate position information from an IP address using, for example, the database in which the IP address of the user terminal is associated with a location information of a service provider which distributes the IP address. Further, the position information acquisition unit 24 uses, for example, the database regarding the position information of the Wi-Fi base station (for example, a public wireless LAN spot), such that the position may be measured from the base station ID contained in the notification information received from the base station to acquire the corresponding position information. In the meantime, the position information acquisition method is not limited thereto. For example, plural acquisition methods among the other acquisition methods described above may be performed to acquire the position information based on average results of the plural acquisition methods or based on a priority level of the acquisition method. The acquired position information may be stored in the storage unit 23, and read as needed.

When the user terminal 11 is turned ON to be activated due to supplying of electrical power, the authentication unit 25 of the user terminal 11 authenticates whether activation is allowable. Specifically, the authentication unit 25 collates, for example, the current position information with the activation permitted position information included in the activation determination condition table stored in the storage unit 23 in advance to determine whether the activation is allowable.

When the authentication result by the authentication unit 25 is the activation forbiddance, the activation inquiring unit 26 transmits the unique identification information (for example, unique information of the terminal) to the management server 12, causing the management server 12 to inquire whether activation is allowable.

The activation inquiring unit 26 may inquire the management server 12 whether the activation is allowable as described above in a case where the activation determination condition is not present in the storage unit 23, in addition to a case where the activation permission is not obtained from the authentication unit 25. The activation inquiring unit 26 may inquire the management server 12 as to whether the activation is allowable even in a case where a predetermined time has elapsed after the activation permission is obtained from the management server 12, or in a case where information indicating that the activation determination condition is updated is received from the management server 12.

Further, the activation inquiring unit 26 acquires a reply for the inquiry as to whether the activation is allowable from the management server 12. The activation inquiring unit 26 acquires the activation determination condition described above in a case where the activation permission may be obtained from the management server 12 with respect to the inquiry made to the management server 12 as to whether the activation is allowable. The acquired activation determination condition is stored in, for example, the storage unit 23, and read as needed on or after the next time of activation authentication.

The activation unit 27 activates, for example, the OS installed in the user terminal 11 in a case where the activation permission is obtained from the authentication result by the authentication unit 25, or in a case where the activation permission is obtained from the result of the inquiry made by the activation inquiring unit 26. In the meantime, an object to be subjected to the activation authentication in the present embodiment is not limited to the OS, but may also include individual software or application which performs a predetermined process and installed in the user terminal 11. That is, a process in which the activation authentication is performed at the time of activation of the individual software installed in the user terminal 11 to activate only the software for which the activation is permitted may also be performed in the present embodiment.

The transmission/reception unit 28 is a communication unit for transmitting/receiving data from/to an external apparatus such as for example, the wireless base station 15 or the management server 12, through, for example, the communication network 13. The transmission/reception unit 28 may receive various information stored in the external apparatus in advance and may also transmit the result processed by the user terminal 11 to the external apparatus through the communication network 13. In the meantime, the transmission/reception unit 28 may include the function of the antenna unit 14 described above.

The control unit 29 controls the entirety of constitutional units of the user terminal 11. Specifically, the control unit 29 performs the respective controls for the activation authentication based on, for example, the instruction from the input unit 21 instructed by the user. Here, the respective controls include, for example, causing the position information acquisition unit 24 described above to acquire the position information, causing the authentication unit 25 to authenticate, causing the activation inquiring unit 26 to inquire whether the activation is allowable, and causing the activation unit 27 to activate, but is not limited thereto. In the meantime, the controls described above may be performed based on an execution of program or an execution of a predetermined event or command according to the instruction from the user, otherwise, may be performed regularly at regular intervals.

### <Example of Hardware Configuration of User Terminal 11>

An execution program (for example, an activation authentication program) capable of causing the computer to execute each function may be installed in, for example, a general purpose PC to implement the activation authentication process in the present embodiment. Here, an example of a hardware configuration in which the activation authentication process according to the present embodiment may be implemented will be described with reference to accompanying drawings.

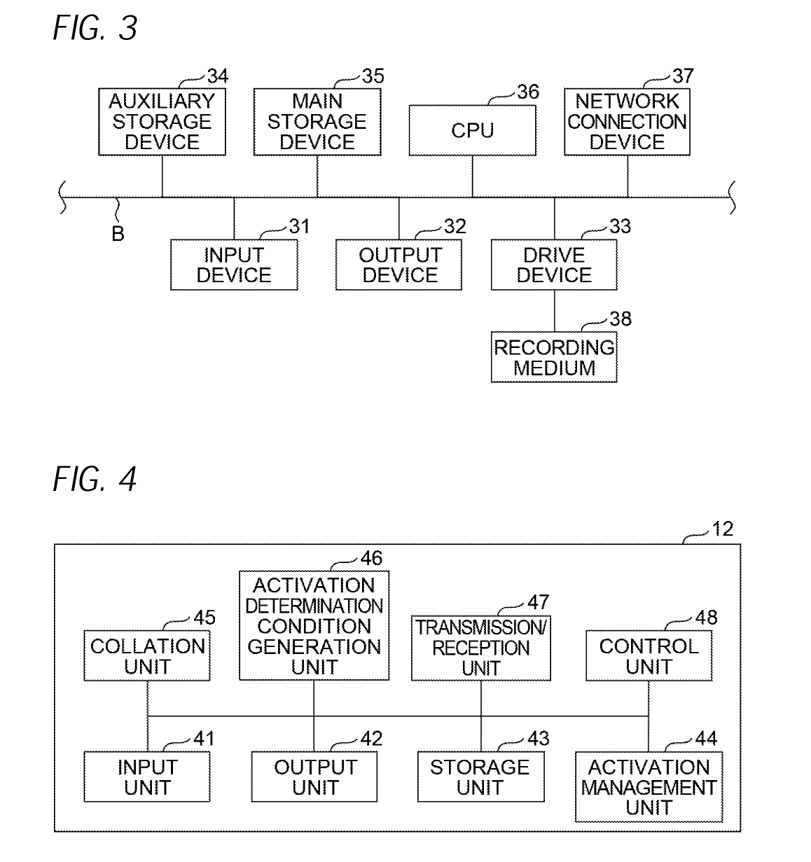

FIG. 3 is a view illustrating an example of a hardware configuration capable of implementing the activation authentication process according to the present embodiment. The computer main body illustrated in FIG. 3 is configured to include an input device 31, an output device 32, a drive device 33, an auxiliary storage device 34, a main storage device 35, a Central Processing Unit (CPU) 36 which performs various controls, and a network connection device 37, and these components are connected with each other through a system bus B.

The input device 31 is provided with a pointing device such as a keyboard and a mouse manipulated by the user or a voice input device such as a microphone, and thus, receives inputs, such as instruction to execute the program from the user, various manipulation information, and information for activating software.

The output device 32 is provided with a display used for displaying data and various windows needed for manipulating the computer main body used to perform processes according to the present embodiment. The output device 32 displays the progress and results of the control program provided in the CPU 36. Further, the output device 32 may print out the process result described above in, for example, a printing medium such as the paper to present the result to the user.

Here, the execution program installed in the computer main body is provided by a portable recording medium 38 such as for example, a Universal Serial Bus (USB) memory, a CD-ROM, or a DVD, in the present embodiment. The recording medium 38 having the program recorded therein may be set in the drive device 33 and thus, the execution program included in the recording medium 38 is installed in the auxiliary storage device 34 from the recording medium 38 through the drive device 33 based on a control signal from the CPU 36.

The auxiliary storage device 34 in the present embodiment stores the execution program or a control program installed in the computer as well as the execution progress or the execution result based on the control signal from the CPU 36. Further, the auxiliary storage device 34 may read or write necessary information from or to each information stored based on the control signal from the CPU 36.

In the meantime, the auxiliary storage device 34 is, for example, a Hard Disk Drive (HDD) or a Solid State Drive (SSD), and corresponds to, for example, the storage unit 23 described above.

The main storage device 35 stores the execution program read from the auxiliary storage device 34 by the CPU 36. Also, the main storage device 35 may be a Read Only Memory (ROM) or a Random Access Memory (RAM).

The CPU 36 may control various operations including data input/output with the respective hardware constitutional components or control the entire process of the computer based on the control program such as for example, the operating system and the execution program stored in the main storage device 35 to implement the respective processes. In the meantime, various information needed during the execution of the program may be acquired from the auxiliary storage device 34, and further, the execution result may be stored in the auxiliary storage device.

Specifically, the CPU 36 executes the activation authentication program installed in the auxiliary storage device 34 based on the program execution instruction obtained from, for example, the input device 31 to perform a process corresponding to the program on the main storage device 35.

For example, the CPU 36 executes the activation authentication program to perform the position information acquisition by the position information acquisition unit 24, the activation authentication by the authentication unit 25, inquiry whether activation is allowable by the activation inquiring unit 26, and may also perform an execution control for the activation of the OS or software by the activation unit 27. In the meantime, the contents processed in the CPU 36 are not limited to the contents described above. The contents (execution progress or execution results) executed by the CPU 36 may be stored in the auxiliary storage device 34 as needed.

The network connection device 37 is connected with the communication network 13 based on a control signal from the CPU 36 to acquire the execution program or software, the position information, and the activation determination condition from the external apparatus connected to the communication network 13. Further, the network connection device 37 may provide the external apparatus with the execution results obtained by executing the program or the execution program itself in the present embodiment. Further, the network connection device 37 may include the antenna unit 14 described above.

The activation authentication process according to the present embodiment may be executed by the hardware configuration described above. Further, a program is installed, such that the activation authentication process according to the present embodiment may be readily implemented with, for example, a general purpose PC.

### <Example of Functional Configuration of Management Server 12>

FIG. 4 is a view illustrating an example of a functional configuration of the management server according to the present embodiment. The management server 12 illustrated in FIG. 4 is provided with an input unit 41, an output unit 42, a storage unit 43, an activation management unit 44, a collation unit 45, an activation determination condition generation unit 46, a transmission/reception unit 47, and a control unit 48.

The input unit 41 receives various inputs such as for example, start/end of various instructions, settings from the manager who uses the management server 12. Specifically, the input unit 41 receives various instructions such as for example, activation management instruction or collation instruction, activation determination condition generation instruction or transmission/reception instruction, in the present embodiment.

Information acquired by the input unit 41 may be, for example, input by an input interface such as a keyboard or a mouse, touch panel type input using a monitor screen, or input using a manipulation key. Further, the input unit 41 may include a voice input unit in which voice is input by, for example, a microphone.

The output unit 42 outputs contents input by the input unit 41 or performed based on the input contents. In the meantime, the output unit 42 may include a displaying unit such as for example, a display or a monitor when outputting by displaying on the screen, or include a voice outputting unit such as for example, a speaker when outputting with voice. Further, the input unit 21 and the output unit 42 may be an integral type input/output unit such as for example, a touch panel.

The storage unit 43 stores various information needed in the present embodiment. Specifically, the storage unit 43 stores various information such as for example, the activation management information (for example, activation management table) or the collation result, the activation determination condition, and various history information.

Further, the storage unit 43 may read or write the stored various information at a predetermined timing as needed. The storage unit 43 is a collection of various types of information described above, and may have a function of a database which is systematically configured such that the information may be retrieved and extracted using, for example, keyword. In the meantime, the storage unit 43 is, for example, a hard disk or a memory.

The activation management unit 44 sets or updates the activation management table in which the determination condition, such as an individual activation prohibited position information or a presence/absence of a report of the theft damage with respect to, for example, one or plural user terminals 11 are included, thereby performing the activation management. The activation management table is stored in, for example, the storage unit 43 and read as needed.

Further, the activation management unit 44 may transmit information(for example, determination condition update information) indicating that the determination condition is updated to the user terminal 11 when, for example, the determination condition is updated. Further, the activation management unit 44 may transmit the instruction information to delete the previous activation determination condition stored in the user terminal 11 or the updated information itself to the user terminal 11. Accordingly, the user terminal 11 may surely cause the management server 12 to determine whether the activation is allowable at the time of the next activation authentication and thus, the collation using the current activation determination condition may be performed.

When there is an inquiry from the user terminal 11 as to whether the activation is allowable, the collation unit 45 collates the activation determination condition described above with, for example, the identification information and the position information of the user terminal 11 transmitted at the same time as the inquiry to determine whether the activation of the user terminal 11, which has inquired whether the activation is allowable, may be allowed. In the meantime, the collation result is stored in, for example, the storage unit 43 and read as needed.

When the collation result by the collation unit 45 is an activation permission, the activation determination condition generation unit 46 generates the activation determination condition to be stored in the storage unit 23 of the user terminal 11. Specifically, the activation determination condition generated by the activation determination condition generation unit 46 includes, for example, information of the position or a range for which the activation is permitted or prohibited, the activation permitted time, and the determination condition update information, but is not limited thereto. The generated activation determination condition is transmitted by the transmission/reception unit 47 to the associated user terminal 11 through the communication network 13.

The transmission/reception unit 47 is a communication unit for transmitting/receiving data from/to the external apparatus of, for example, the user terminal 11 or the wireless base station 15, through, for example, the communication network 13 or the wireless base station 15. The transmission/reception unit 28 may receive various information stored in the external apparatus in advance and may also transmit the result processed by the management server 12 to the external apparatus through the communication network 13.

The control unit 48 controls the entirety of constitutional units of the management server 12. Specifically, the control unit 48 performs the respective controls for the activation authentication based on, for example, the instruction from the input unit 41 by the manager. Here, the respective controls include, for example, causing the activation management unit 44 to manage activation of the user terminal 11, causing the collation unit 45 to perform the collation, and causing the activation determination condition generation unit 46 to generate the activation determination condition, but is not limited thereto. In the meantime, the controls described above may be performed based on execution of the program or generation of a predetermined event according to instruction by the manager, otherwise, may be performed regularly at regular intervals.

### <Example of Hardware Configuration of Management Server 12>

Here, the hardware configuration in the user terminal 11 as illustrated in FIG. 3 described above may be applied to a hardware configuration of the management server 12 described above and thus, detailed descriptions thereof will be omitted.

In the meantime, in the hardware configuration of the management server 12, the CPU 36 executes the activation authentication program to perform an activation management by the activation management unit 44, a collation by the collation unit 45, and an activation determination condition generation by the activation determination condition generation unit 46. The contents processed in the CPU 36 are not limited to the contents described above.

### First Embodiment

### <Activation Authentication Process in User Terminal 11>

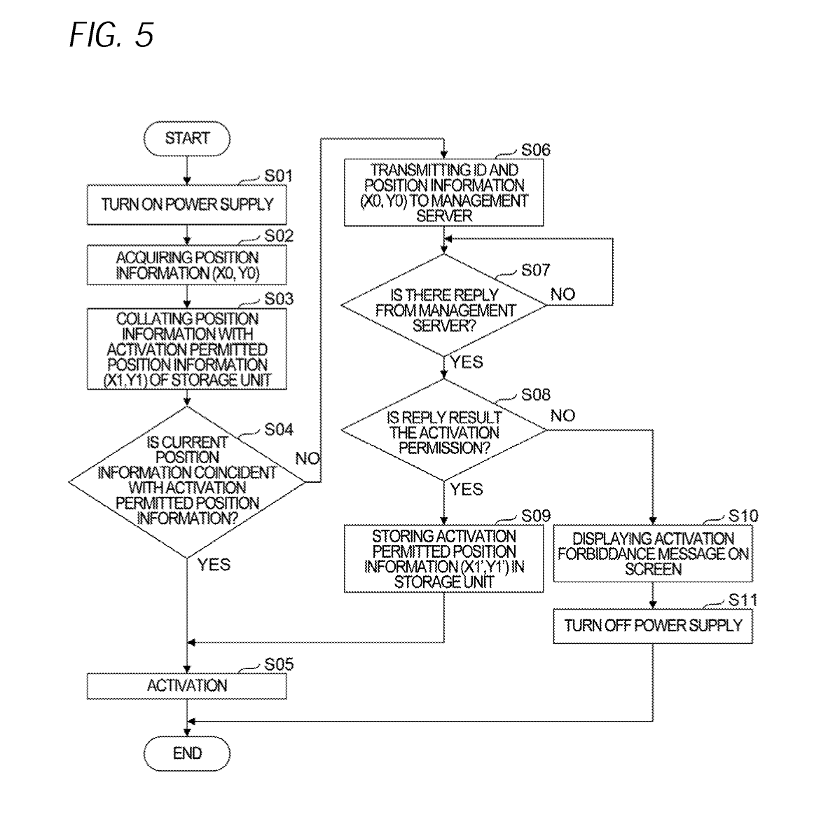

A first embodiment of the activation authentication process in the user terminal 11 will be described next using a flowchart. FIG. 5 is a flowchart illustrating a first embodiment of the activation authentication process in the user terminal. In an example of FIG. 5, descriptions will be made on the assumption that the previous activation determination condition is stored in advance.

In the example of FIG. 5, when it is detected that the power supply of the user terminal 11 is turned ON by the user (S01), the position information acquisition unit 24 acquires the current position information (X0,Y0) (S02). In the meantime, the current position information may be, for example, the position information of the wireless base station 15 included in the notification information received from the wireless base station 15 nearest to the user terminal 11 described above or acquired by, for example, the GPS function, but is not limited thereto.

Subsequently, the authentication unit 25 performs the position information collation using the current position information acquired and the activation permitted position information (X1,Y1) as an example of the activation determination condition stored in the storage unit 23 (S03). In the meantime, the activation permitted position information may also include a single position information as well as plural position information.

Further, the authentication unit 25 determines whether the current position information is coincident with the activation permitted position information (S04). In the meantime, upon determining whether the current position information is coincident with the activation permitted position information in the first embodiment, it is determined that these position information are coincident with each other in a case where, for example, the position information and the activation permitted position information are completely coincident with each other, as well as in a case where difference between the position information and the activation permitted position information falls within a predetermined allowable range. Here, when it is determined that the current position information is coincident with the activation permitted position information (“YES” at step S04), the activation unit 27 activates the user terminal 11 (S05).

Further, when it is determined that the current position information is not coincident with the activation permitted position information (“NO” at step S04), the activation inquiring unit 26 transmits an identification information (ID) of the user terminal 11 and the current position information (X0,Y0) to the management server 12 (S06). That is, in the process of S06, the user terminal 11 inquires the management server 12 as to whether the activation is allowable as described above.

Subsequently, the activation inquiring unit 26 determines whether a reply for the inquiry described above has been sent from the management server 12 (S07). When it is determined that the reply has not been sent from the management server 12 (“NO” at step S07), the unit 26 waits until the reply is received. Further, when it is determined that the reply has been sent from the management server 12 (“YES” at step S07), the activation inquiring unit 26 determines whether the reply result is activation permission (S08).

When it is determined that the reply result is the activation permission (“YES” at step S08), the activation inquiring unit 26 stores the activation permitted position information (X1′,Y1′) included in the activation determination condition transmitted from the management server 12 in the storage unit 23 and updates the activation determination condition (S09). Accordingly, the activation permitted position information (X1′,Y1′) becomes the activation determination condition (activation permitted position information (X1,Y1)) in the process of S03 at the time of next activation authentication. Thereafter, the activation unit 27 performs the activation process of step S05 as described above.

When it is determined that the reply result from the management server 12 is not the activation permission in the process of step S08 (“NO” at step S08), the activation inquiring unit 26 displays a message indicating that activation is not allowed (for example, a message indicative of activation forbiddance) due to an authentication error on a screen of the user terminal 11 (S10). Further, the activation inquiring unit 26 turns the power supply of the user terminal 11 OFF (S11). In the meantime, the activation inquiring unit 26 may turn the power supply OFF without displaying the message on the screen in the process of step S10 as described above.

In the example of FIG. 5, a control in which the activation is permitted is performed in a case where the activation permitted position information included in the activation determination condition and the current position are coincident with each other when comparing the activation permitted position information and the current position, but is not limited thereto. For example, the authentication unit 25 may permit the activation of the user terminal 11 in a case where the activation prohibited position information included in the activation determination condition is not coincident with the current position when comparing the activation prohibited position information and the current position information.

### <Activation Authentication Process in Management Server 12>

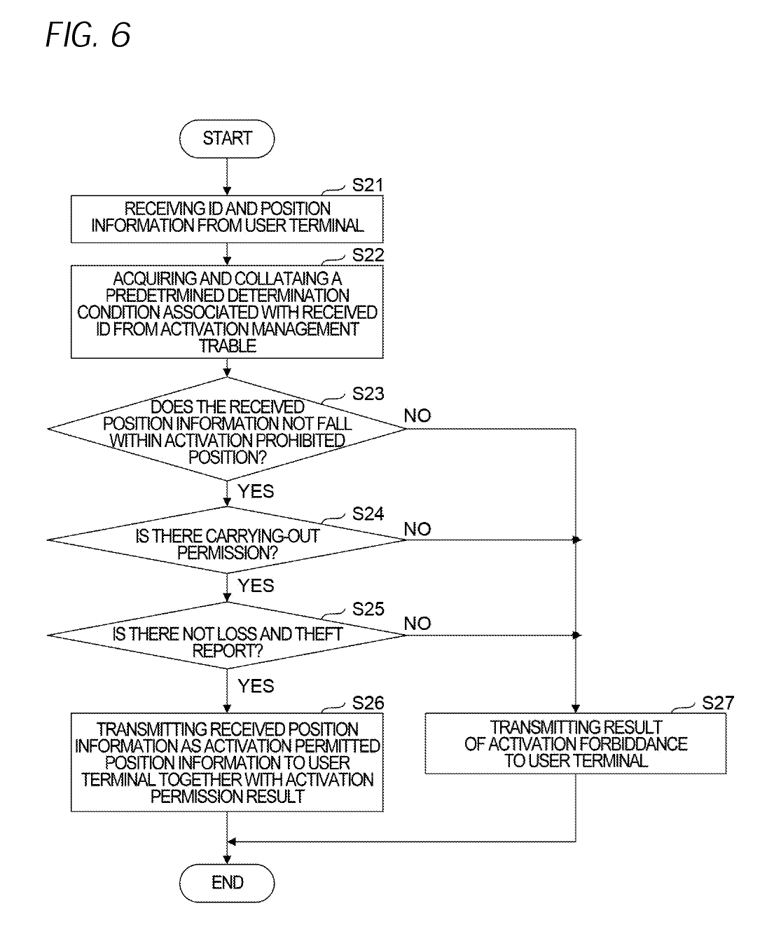

A first embodiment of the activation authentication process in the manager server 12 for the first embodiment of the activation authentication process in the user terminal 11 described above will be described using a flowchart. FIG. 6 is a flowchart illustrating a first embodiment of the activation authentication process in the management server.

In the example of FIG. 6, registration of various information into the determination condition (for example, an activation management table) associated with each user terminal 11 stored in the storage unit 43 is performed as a maintenance work for the activation management in the management server 12. In the meantime, examples of various information may include “activation prohibited position information”, “presence/absence of carrying-out permission”, “presence/absence of a loss/theft report”, but is not limited thereto.

In the example of FIG. 6, the collation unit 45 receives, for example, an identification information (ID) identifying the user terminal 11 and the current position information of the user terminal 11 as information for an inquiry of whether activation is allowable from the user terminal 11 (S21). Subsequently, the collation unit 45 acquires the determination condition associated with the received ID from the activation management table stored in the storage unit 43 and performs collation based on a predetermined determination condition (S22).

In the meantime, the activation prohibited position information is included as the determination condition in the first embodiment as illustrated in FIG. 6 and thus, the collation may be performed according to whether the position information is coincident with the activation prohibited position information, but is not limited thereto. For example, when the activation permitted position information is stored in the activation management table, the stored activation permitted position information may be collated with the position information.

The collation unit 45 determines whether the position information received in the process of step S21 does not fall within the activation prohibited position from the collation process result of step S22 (S23). When it is determined that the received position information does not fall within the activation prohibited position (“YES” at step S23), the collation unit 45 subsequently determines whether the carrying-put permission for the user terminal 11 is present (S24).

When it is determined that the carrying-out permission is present (“YES” at step S24), the collation unit 45 subsequently determines whether the loss/theft report is present (S25). Here, when it is determined that the loss/theft report is not present (“YES” at step S25), the activation determination condition generation unit 46 transmits the position information received in the process of step S21 together with the result of the activation permission to the user terminal 11 as the activation permitted position information (S26).

When it is determined that the received position information falls within the activation prohibited position in the process of step S23 (“NO” at step S23), the collation unit 45 transmits the result of the activation forbiddance to the user terminal 11 (S27). In the meantime, when it is determined that the carrying-out permission is not present in the process of step S24 (“NO” at step S24) or the loss/theft report is present (“NO” at step S25), the collation unit 45 transmits the result of the activation forbiddance to the user terminal 11 as described above (S27).

In the example of FIG. 6, comparison of the position information received from the user terminal 21 with the activation prohibited position information is used for determining whether activation is allowable, but is not limited thereto. For example, the activation permitted position information may be used to be compared with the position information received from the user terminal as the determination condition. Further, in the example of FIG. 6, the position information received from the user terminal 11 is used as the activation permitted position information to generate the activation determination condition. The activation determination condition is then transmitted together with the result of the activation permission to the user terminal, but the information to be transmitted is not limited thereto, and, for example, the activation prohibited position information may be transmitted to the user terminal 11.

Here, at least one process among the processes of steps S23, S24, and S25 described above may be executed to perform the activation authentication. Further, the process sequence of steps S23, S24, and S25 is not limited to the example illustrated in FIG. 6, but may be arbitrarily modified.

### <Example of Data Associated>

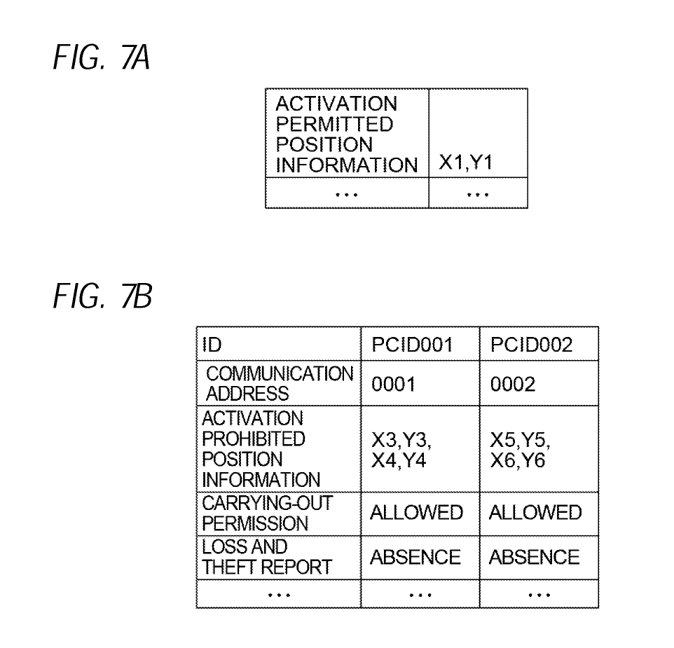

Here, FIGS. 7A and 7B are views illustrating an example of data associated with the first embodiment. FIG. 7A illustrates an example of the activation determination condition table stored in the user terminal 11 and FIG. 7B illustrates an example of the activation management table stored in the management server 12.

The activation determination condition table illustrated in FIG. 7A includes, for example, “activation permitted position information” as an item, but is not limited thereto. For example, the position information such as the coordinates at the time of the previous activation permission is stored in the “activation permitted position information”, but the position information to be stored is not limited thereto, and the position information set according to the instruction from the management server 12 may be stored.

Further, one or plural position information may be stored in the item of the activation permitted position information. That is, in the first embodiment, when the current position information is coincident with one of plural activation permitted position information, the activation is permitted. In the meantime, information acquired from the management server 12 is stored in the activation determination condition table described above.

Further, the activation management table illustrated in FIG. 7B includes items such as for example, “ID”, “communication address”, “activation prohibited position information”, “carrying-out permission” and “loss/theft report”, but is not limited thereto.

The “ID” is a unique identification information for identifying the user terminal 11. In the meantime, the “ID” may be, for example, a terminal production number, but is not limited thereto. The “communication address” is an address information for connecting and communicating with the user terminal 11 through the communication network 13. Further, the address information may be, for example, an IP address, but is not limited thereto.

The “activation prohibited position information” sets a location where the activation is prohibited for each user terminal 11. Further, the “activation permitted position information” described above other than the “activation prohibited position information” may be set in the first embodiment.

The “carrying-out permission” is information indicating whether the user terminal 11 may be carried out from a predetermined location. For example, carrying-out of the user terminal 11 in which important data is stored is prohibited from the view point of leakage of information (“carrying-out forbiddance”). Further, for example, the user terminal 11 which executes a specific process at a specific place is not needed to carry-out and thus, the “carrying-out prohibition” is set.

The information whether a loss report or a theft report for the user terminal 11 is present is stored in the item of “loss/theft report”.

The information set in the activation management table illustrated in FIG. 7B is set in advance by the manager, but is not limited thereto, and may be set by the user of the user terminal 11.

Here, an example of the activation authentication using the activation determination condition table illustrated in FIG. 7A and the activation management table illustrated in FIG. 7B will be described. When the ID and the position information are received from the user terminal 11, the management server 12 extracts the determination condition associated with the ID from the activation management table and determines whether the activation is allowable based on the determination condition. As for the determination condition, the activation prohibited position information, the presence/absence of the carrying-out permission, and the presence/absence of the loss/theft report are set in advance as included in the activation management table illustrated in FIG. 7B. And the activation of the user terminal 11 which inquires whether the activation is allowable is permitted in a case where the location of the user terminal 11 corresponds to a position which does not fall within the activation prohibited position, the carrying-out permission and the loss/theft report for the user terminal 11 are set as presence and as absence, respectively.

Further, in the first embodiment, in a case where the activation is permitted, the management server 12 sets the current position information sent from the user terminal 11 as the activation permitted position information and transmits the current position information to the user terminal 11 together with a determination result of the activation permission. The user terminal 11 stores the activation permitted position information in the activation determination condition table illustrated in FIG. 7A. Accordingly, the user terminal 11 may collate the current position information with the activation permitted position information stored in the activation determination condition table to perform the activation authentication at the time of the next activation. Also, when the activation is permitted, the user terminal 11 may authenticate to activate without accessing the management server 12. Accordingly, unnecessary communications may be prevented thereby reducing the communication traffic. Further, limitation of use may be ensured safely in the first embodiment.

### Second Embodiment

### <Activation Authentication Process in User Terminal 11>

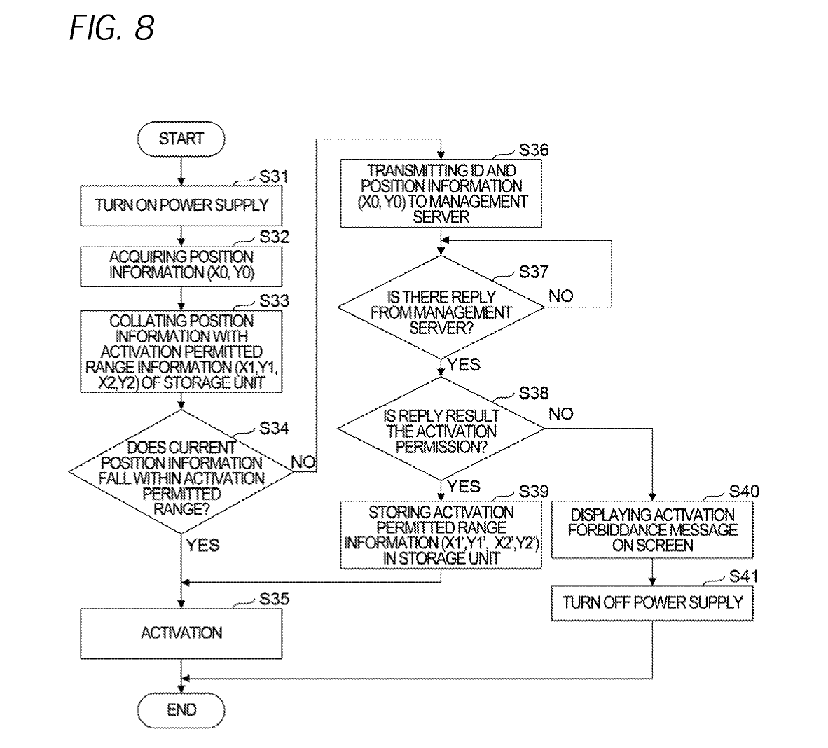

A second embodiment of the activation authentication process in the user terminal 11 will be described using a flowchart. FIG. 8 is a flowchart illustrating the second embodiment of the activation authentication process in the user terminal.

In the second embodiment, when the reply result is the activation permission, the position information to be transmitted to the user terminal 11 is transmitted to the user terminal 11 as information in which a predetermined range is added to the position information sent from the user terminal 11. Accordingly, even in a case where the user terminal 11 is to be slightly moved, the activation authentication may be performed without accessing the management server 12. Hereinafter, descriptions will be made on the assumption that the previous activation determination condition is stored in advance.

In the example of FIG. 8, when it is detected that the power supply of the user terminal 11 is turned ON by the user (S31), the position information acquisition unit 24 acquires the acquired current position information (X0,Y0) as described above (S32). Subsequently, the authentication unit 25 collates the position information with the activation permitted range information (X1,Y1,X2,Y2) using the acquired current position information and the activation permitted range information as an example of the activation determination condition stored in the storage unit 23 (S33). In the meantime, the activation permitted range information may also include a single range information as well as plural range information.

The authentication unit 25 determines whether the current position information falls within the activation permitted range information (S34). Here, when it is determined that the current position information falls within the activation permitted range information (“YES” at step S34), the activation unit 27 activates the user terminal 11 (S35).

When it is determined that the current position information does not fall within the activation permitted range information (“NO” at step S34), the activation inquiring unit 26 transmits an identification information (ID) of the user terminal 11 and the current position information (X0,Y0) to the management server 12 (S36). That is, in the process of S36, the user terminal 11 inquires the management server 12 as to whether the activation is allowable as described above.

Subsequently, the activation inquiring unit 26 determines whether a reply for the inquiry described above has been sent from the management server 12 (S37). When it is determined that the reply has not been sent from the management server 12 (“NO” at step S37), the unit 26 waits until the reply is received. Further, when it is determined that the reply has been sent from the management server 12 (“YES” at step S37), the activation inquiring unit 26 determines whether the reply result is the activation permission (S38).

When it is determined that the reply result is the activation permission (“YES” at step S38), the activation inquiring unit 26 stores the activation permitted range information (X1′,Y1′, X2′,Y2′) included in the activation determination condition transmitted from the management server 12 in the storage unit 23 and updates the activation determination condition (S39). Accordingly, the activation permitted range information (X1′,Y1′, X2′,Y2′) becomes the activation determination condition (for example, activation permitted range information (X1,Y1, X2,Y2)) in the process of S33 at the time of the next activation authentication. Thereafter, the activation unit 27 performs the activation process of step S35 as described above.

When it is determined that the reply result sent from the management server 12 is not the activation permission in the process of step S38 (“NO” at step S38), the activation inquiring unit 26 displays a message indicating that activation is not allowed (for example, a message indicative of activation forbiddance) due to an authentication error on a screen of the user terminal 11 (S40). Further, the activation inquiring unit 26 turns OFF the power supply of the user terminal 11 (S41). In the meantime, the activation inquiring unit 26 may turn OFF the power supply without displaying the message on the screen in the process of step S40 as described above.

### <Activation Authentication Process in Management Server 12>

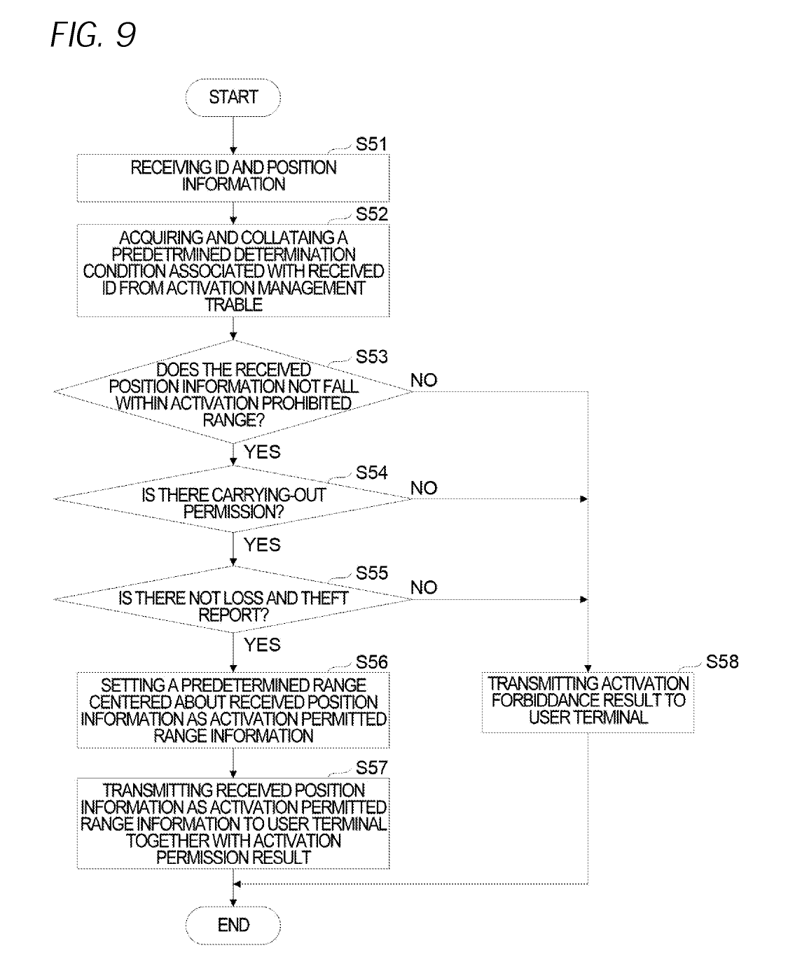

A second embodiment of the activation authentication process in the manager server 12 for the second embodiment of the activation authentication process in the user terminal 11 as described above will be described using a flowchart. FIG. 9 is a flowchart illustrating a second embodiment of the activation authentication process in the management server.

In the example of FIG. 9, registration of various information into the determination condition (for example, activation management table) associated with each user terminal 11 stored in the storage unit 43 is performed as a maintenance work for the activation management in the management server 12. In the meantime, examples of various information include “activation prohibited range information”, “presence/absence of carrying-out permission”, and “presence/absence of a loss/theft report”, but are not limited thereto.

In the example of FIG. 9, the collation unit 45 receives, for example, an identification information (ID) identifying the user terminal 11 and the current position information of the user terminal 11 as information for an inquiry as to whether activation is allowable from the user terminal 11 (S51). Subsequently, the collation unit 45 acquires the determination condition associated with the received ID from the activation management table stored in the storage unit 43 and performs collation based on a predetermined determination condition (S52).

In the second embodiment illustrated in FIG. 9, for example, the position information is collated with the activation prohibited range information included in the determination condition, but is not limited thereto. For example, in the second embodiment, when the activation permitted range information is stored in the activation management table as the determination condition, the stored activation permitted range may be collated with the position information.

The collation unit 45 determines whether the position information received in the process at step S51 does not fall within the activation prohibited range from the result of the collation process of step S52 (S53). When it is determined that the received position information is fallen out of the activation prohibited range (“YES” at step S53), the collation unit 45 subsequently determines whether the carrying-out permission for the user terminal 11 is present (S54).

When it is determined that the carrying-out permission is present (“YES” at step S54), the collation unit 45 subsequently determines whether the loss/theft report is present (S55). Here, when it is determined that the loss/theft report is not present (“YES” at step S55), the activation determination condition generation unit 46 sets a predetermined range centered around the position information received at the process of step S51 as the activation permitted range information (S56), and transmits the activation permitted range information and the result of the activation permission to the user terminal 11 (S57).

When it is determined that the received position information falls within the activation prohibited range in the process of step S53 (“NO” at step S53), the collation unit 45 transmits the result of the activation forbiddance to the user terminal 11 (S58). In the meantime, when it is determined that that the carrying-out permission is not present in the process of step S54 (“NO” at step S54) or the loss/theft report is present in the process of step S55 (“NO” at step S55), the collation unit 45 transmits the result of the activation forbiddance to the user terminal 11 as described above (S58).

Here, at least one process among the processes of steps S53, S54, and S55 described above may be executed to perform the activation authentication. Further, the process sequence of steps S53, S54, and S25 is not limited to the example illustrated in FIG. 9, but may be arbitrarily modified.

### <Example of Data Associated>

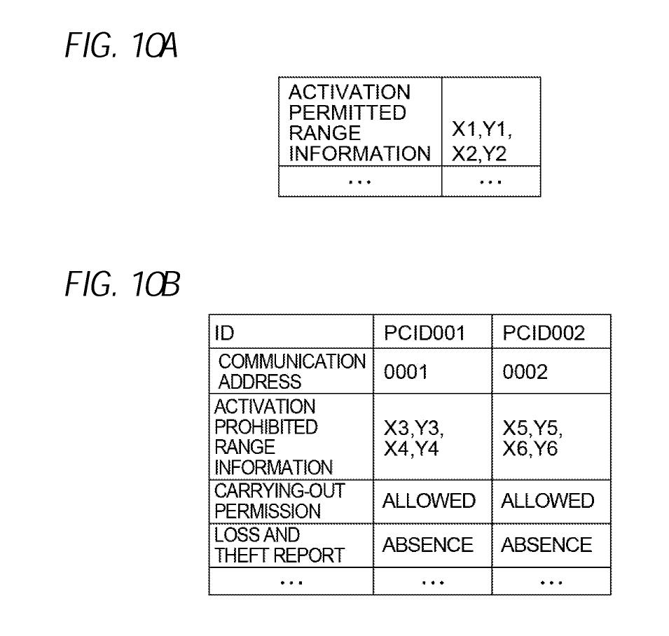

FIGS. 10A and 10B are views illustrating an example of data associated with the first embodiment. In the meantime, FIG. 10A illustrates an example of the activation determination condition table stored in the user terminal 11 and FIG. 10B illustrates an example of the activation management table stored in the management server 12.

The activation determination condition table illustrated in FIG. 10A includes, for example, “activation permitted range information” as an item, but is not limited thereto. For example, the activation permitted range information at the time of the previous activation permission is stored in the item of the activation permitted range information, but the activation permitted range information to be stored is not limited thereto, and the activation permitted range information set according to the instruction from the management server 12 may be stored.

One or plural range information may be stored in the item of the activation permitted position information. That is, in the second embodiment, when the current position information falls within one of plural activation permitted range information, the activation is permitted. In the meantime, information acquired from the management server 12 is stored in the activation determination condition table as described above.

The activation management table illustrated in FIG. 10B includes items, for example, “ID”, “communication address”, “activation prohibited range information”, “carrying-out permission” and “a loss/theft report”, but is not limited thereto.

The “ID” is a unique identification information for identifying the user terminal 11. In the meantime, the “ID” may be, for example, a terminal production number, but is not limited thereto. The “communication address” is an address information for connecting and communicating with the user terminal 11 through the communication network 13. Further, the address information may be, for example, an IP address, but is not limited thereto.

The “activation prohibited range information” sets a range where the activation is prohibited for each user terminal 11. Further, the “activation permitted range information” may be set other than the “activation prohibited range information” as described above.

The “carrying-out permission” is information indicating whether the user terminal 11 may be carried out from a predetermined location as described above. Further, the “loss/theft report” refers to information whether the loss/theft report for the user terminal 11 is present.

The information set in the activation management table illustrated in FIG. 10B is set in advance by the manager, but is not limited thereto, and the information may be set by the user of the user terminal 11.

Descriptions will be made hereinbelow for an example of the activation authentication using the activation determination condition table illustrated in FIG. 10A and the activation management table illustrated in FIG. 10B. When the ID and the position information are received from the user terminal 11, the management server 12 extracts the determination condition associated with the ID from the activation management table. The management server 12 then determines whether the activation is allowable based on the extracted determination condition. The activation prohibited range information, the presence/absence of the carrying-out permission, the presence/absence of the loss/theft report are set in advance as the determination condition included in the activation management table as illustrated in FIG. 10B. The activation of the user terminal 11 which inquires whether the activation is allowable is permitted in a case where the user terminal 11 is located at a position which does not fall within the activation prohibited range, and the carrying-out permission and the loss/theft report for the user terminal 11 are set as presence and as absence, respectively.

In the second embodiment, in a case of the activation permission, the management server 12 sets a predetermined range centered around the current position information sent from the user terminal 11 as the activation permitted range information. The management server 12 then transmits the activation permitted range information together with a determination result of the activation permission to the user terminal 11.

The predetermined range may be a range covered by, for example, a circle centered around the current position (X0,Y0). Further, another example of the predetermined range may include, for example, a range covered by a rectangle in which the current position (X0,Y0) is included as a center and two vertices (X1′,Y1′), (X2′,Y2′) are spaced apart from the current position (X0,Y0) by a predetermined equidistance to form a diagonal, but is not limited thereto.

The user terminal 11 stores the activation permitted range information in the activation determination condition table illustrated in FIG. 10A. Accordingly, the user terminal 11 may collate the current position information with the activation permitted range information stored in the activation determination condition table to perform the activation authentication at the time of the next activation. Also, when the activation is permitted, the user terminal 11 may authenticate to activate without accessing the management server 12. Accordingly, similarly to the first embodiment, unnecessary communications may be prevented to reduce the communication traffic and further, limitation of use may be ensured safely, in the second embodiment.

### Third Embodiment

### <Activation Authentication Process in User Terminal 11>

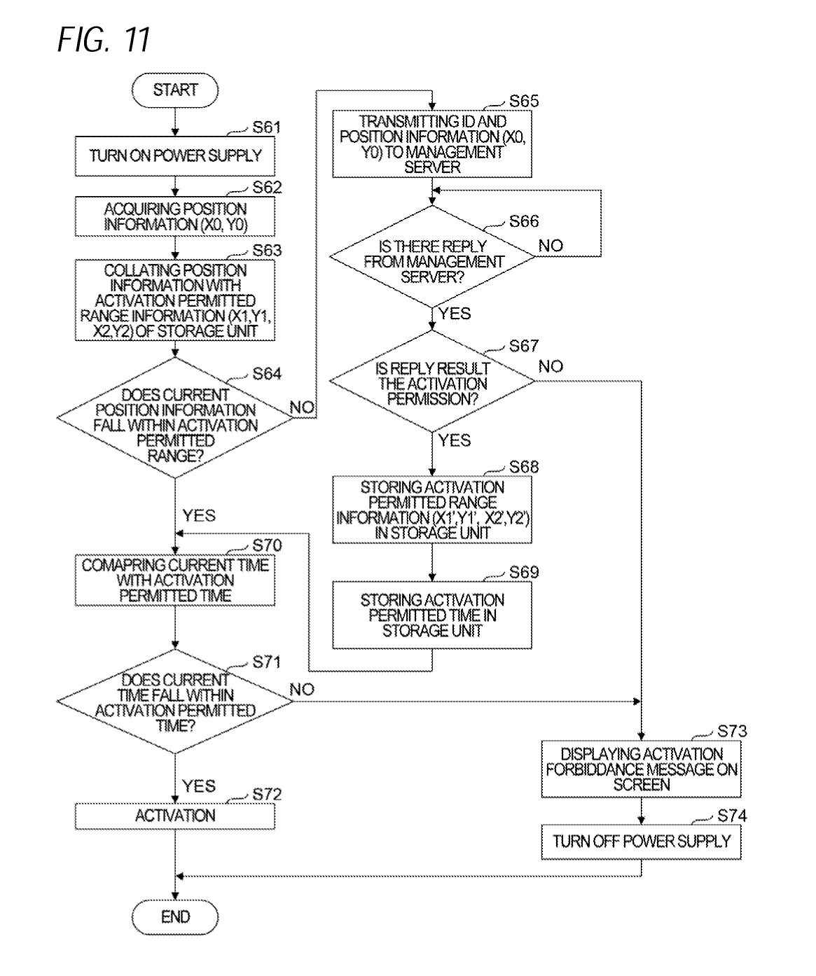

A third embodiment of the activation authentication process in the user terminal 11 will be described using a flowchart. FIG. 11 is a flowchart illustrating the third embodiment of the activation authentication process in the user terminal.

When comparing with the second embodiment as described above, an activation permission authentication for which the activation permitted time is also included as the activation determination condition is performed in the third embodiment. In the meantime, the activation authentication is performed using the activation permitted range information in the third embodiment to be described below, similarly to the second embodiment, but is not limited thereto. For example, as illustrated in the first embodiment, the activation authentication based on the position information may be performed in the third embodiment. Further, descriptions will be made hereinbelow on the assumption that the previous activation determination condition is stored in advance.

In the example of FIG. 11, when it is detected that the power supply of the user terminal 11 is turned ON by the user (S61), the position information acquisition unit 24 acquires the current position information (X0,Y0) as described above (S62). Subsequently, the authentication unit 25 collates the acquired position information with the activation permitted range information (X1,Y1,X2,Y2) using the acquired current position information and the activation permitted range information stored in the storage unit 23 (S63).

Further, the authentication unit 25 determines whether the current position information falls within the activation permitted range (S64). Here, when it is determined that the current position information does not fall within the activation permitted range (“NO” at step S64), the activation inquiring unit 26 transmits an identification information (ID) of the user terminal 11 and the current position information (X0,Y0) to the management server 12 (S65). That is, in the process of S65, the user terminal 11 inquires the management server 12 as to whether the activation is allowable as described above.

Subsequently, the activation inquiring unit 26 determines whether a reply for the inquiry as described above has been sent from the management server 12 is (S66). When it is determined that the reply has not been sent from the management server 12 (“NO” at step S66), the activation inquiring unit 26 waits until the reply is received. Further, when it is determined that the reply has been sent from the management server 12 (“YES” at step S66), the activation inquiring unit 26 determines whether the reply result is the activation permission (S67).

When it is determined that the reply result is the activation permission (“YES” at step S67), the activation inquiring unit 26 stores the activation permitted range information (X1′,Y1′, X2′,Y2′) included in the activation determination condition transmitted from the management server 12 in the storage unit 23 and updates the activation determination condition (S68). Accordingly, the activation permitted range information (X1′,Y1′, X2′,Y2′) becomes the activation determination condition (activation permitted range information (X1,Y1, X2,Y2)) in the process of S63 at the time of the next activation authentication. Further, the activation inquiring unit 26 stores the activation permitted time obtained from the management server 12 in the storage unit 23 to update the activation permitted time (S69).

When it is determined that the position information falls within the activation permitted range in the process of S64 (“YES” at step S64), or after completion of the process of S69, the authentication unit 25 compares the current time and the activation permitted time (S70) to determine whether the current time falls within the activation permitted time (S71). When it is determined that the current time falls within the activation permitted time (“YES” at step S71), the activation unit 27 activates the user terminal 11 (S72).

When it is determined that the reply result from the management server 12 is not the activation permission in the process of step S67 (“NO” at step S67) or when it is determined that the current time does not fall within the activation permitted time (“NO” at step S71), the activation inquiring unit 26 displays a message indicating that activation is not allowable (for example, a message indicative of activation forbiddance) on a screen of the user terminal 11 (S73). In the meantime, the message indicative of activation forbiddance is, for example, a message indicating that activation is not allowable due to an authentication error, but is not limited thereto. Further, the activation inquiring unit 26 turns OFF the power supply of the user terminal 11 (S74). In the meantime, the activation inquiring unit 26 may turn OFF the power supply without displaying the message on the screen in the process of step S73 as described above.

### <Activation Authentication Process in Management Server 12>

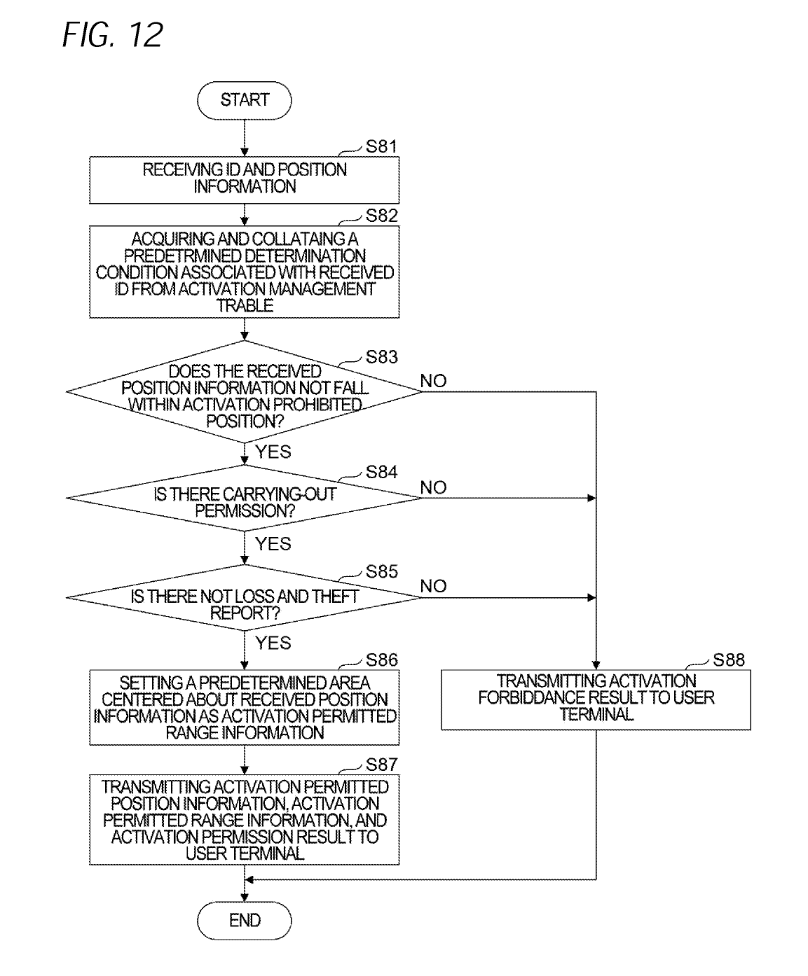

A third embodiment of the activation authentication process in the manager server 12 for the third embodiment of the activation authentication process in the user terminal 11 as described above will be described using a flowchart. FIG. 12 is a flowchart illustrating the third embodiment of the activation authentication process in the management server.

In the example of FIG. 12, registration of various information into the determination condition (for example, activation management table) associated with each user terminal 11 stored in the storage unit 43 is performed as a maintenance work for the activation management in the management server 12. In the meantime, examples of various information include the “activation prohibited range information”, “presence/absence of carrying-out permission”, “presence/absence of a loss/theft report” and “activation permitted time”, but are not limited thereto.

In the example of FIG. 12, the collation unit 45 receives, for example, an identification information (ID) identifying the user terminal 11 and the current position information of the user terminal 11 as information for an inquiry whether activation is allowable from the user terminal 11 (S81). Subsequently, the collation unit 45 acquires the determination condition associated with the received ID from the activation management table stored in the storage unit 43 and performs collation based on a predetermined determination condition (S82).

In the third embodiment illustrated in FIG. 12, for example, the position information is collated with the activation prohibited range information included in the determination condition, but is not limited thereto. For example, similarly to the second embodiment, in the third embodiment, when the activation permitted range information is stored in the activation management table as the determination condition, the stored activation permitted range information may be collated with the position information.

The collation unit 45 determines whether the position information received in the process of step S81 does not fall within the activation prohibited range from the result of the collation process of step S82 (S83). When it is determined that the received position information is fallen out of the activation prohibited range (“YES” at step S83), the collation unit 45 subsequently determines whether the carrying-out permission for the user terminal 11 is present (S84).

When it is determined that the carrying-out permission is present (“YES” at step S84), the collation unit 45 subsequently determines whether the loss/theft report is present (S85). Here, when it is determined that the loss/theft report is not present (“YES” at step S85), the activation determination condition generation unit 46 sets a predetermined range centered around the position information received at the process of step S81 as the activation permitted range information (S86). The activation determination condition generation unit 46 then transmits the activation permitted time based on the current time, the activation permitted range information and the result of the activation permission to the user terminal 11 (S87).

When it is determined that the received position information falls within the activation prohibited range in the process of step S83 (“NO” at step S83), the collation unit 45 transmits the result of the activation prohibition to the user terminal 11 (S88). In the meantime, when it is determined that that the carrying-out permission is not present in the process of step S84 (“NO” at step S84) or the loss/theft report is present in the process of step S85 (“NO” at step S85), the collation unit 45 transmits the result of the activation forbiddance to the user terminal 11 as described above (S88).

At least one process among the processes of steps S83, S84, and S85 described above may be executed to perform the activation authentication. Further, the process sequence of steps S83, S84, and S85 is not limited to the example illustrated in FIG. 12, but may be arbitrarily modified.

### <Example of Data Associated>

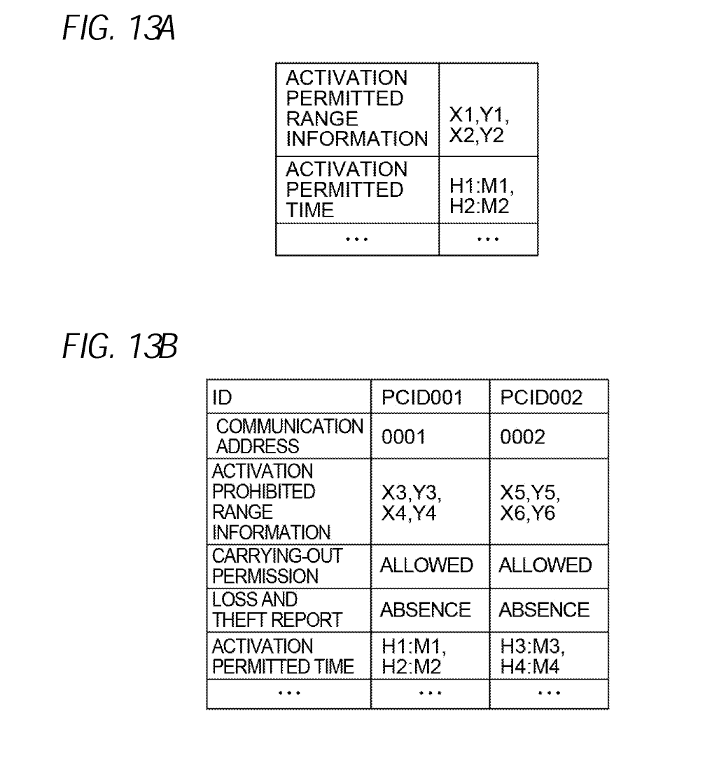

FIGS. 13A and 13B are views illustrating an example of data associated with the third embodiment. FIG. 13A illustrates an example of the activation determination condition table stored in the user terminal 11 and FIG. 13B illustrates an example of the activation management table stored in the management server 12.

The activation determination condition table illustrated in FIG. 13A includes, for example, the “activation permitted range information” and “activation permitted time” as items, but is not limited thereto. Further, the activation management table illustrated in FIG. 13B includes, for example, the “ID”, the “communication address”, the “activation prohibited position information”, the “carrying-out permission”, the “loss/theft report” and the “activation permitted time” as items, but is not limited thereto.

In the third embodiment, the “activation permitted time” is set in the activation determination condition table illustrated in FIG. 13A and the activation management table illustrated in FIG. 13B. For example, time between “H1(hour):M1(min)”˜“H2(hour):M2(min)” set as the activation permitted time is illustrated in FIGS. 13A and 13B. In the third embodiment, the activation permission is performed using the position information as well as the time information based on the activation permitted time described above and thus, more specific activation authentication process may be implemented. In the meantime, start time and end time of the activation permitted time is set in the example of FIG. 13A and FIG. 13B, but is not limited thereto. For example, the activation may be managed in such a manner that a time period (for example, 50 hours from “H1(hour):M1(min)”) spanning from the set time to a predetermined time is set as a range of the activation permitted time.

In the third embodiment, similarly to the second embodiment as described above, in a case of the activation permission, the management server 12 may set a predetermined range centered about, for example, the current position information sent from the user terminal 11 as the activation permitted range information. Further, in the third embodiment, the management server 12 transmits the activation permitted range information, the activation permitted time, and the determination result of the activation permission as described above to the user terminal 11.

In the meantime, the activation authentication is performed using the activation permitted range and the activation permitted time in the third embodiment described above, but is not limited thereto. The activation authentication may be performed using only the activation permitted time. Further, in the third embodiment, the activation permitted time is included in the activation determination condition, but is not limited thereto. For example, the number of times that the user terminal 11 is activated may be included in the activation determination condition in a similar method. In this case, the number of activation times is counted and for example, when the count value exceeds the number of times that the user terminal 11 is activated, the activation may be set to be forbidden. Further, in the third embodiment, both the activation permitted time and the number of times that the user terminal is activated may be included in the determination condition.

### Fourth Embodiment

### <Activation Authentication Process in User Terminal 11>

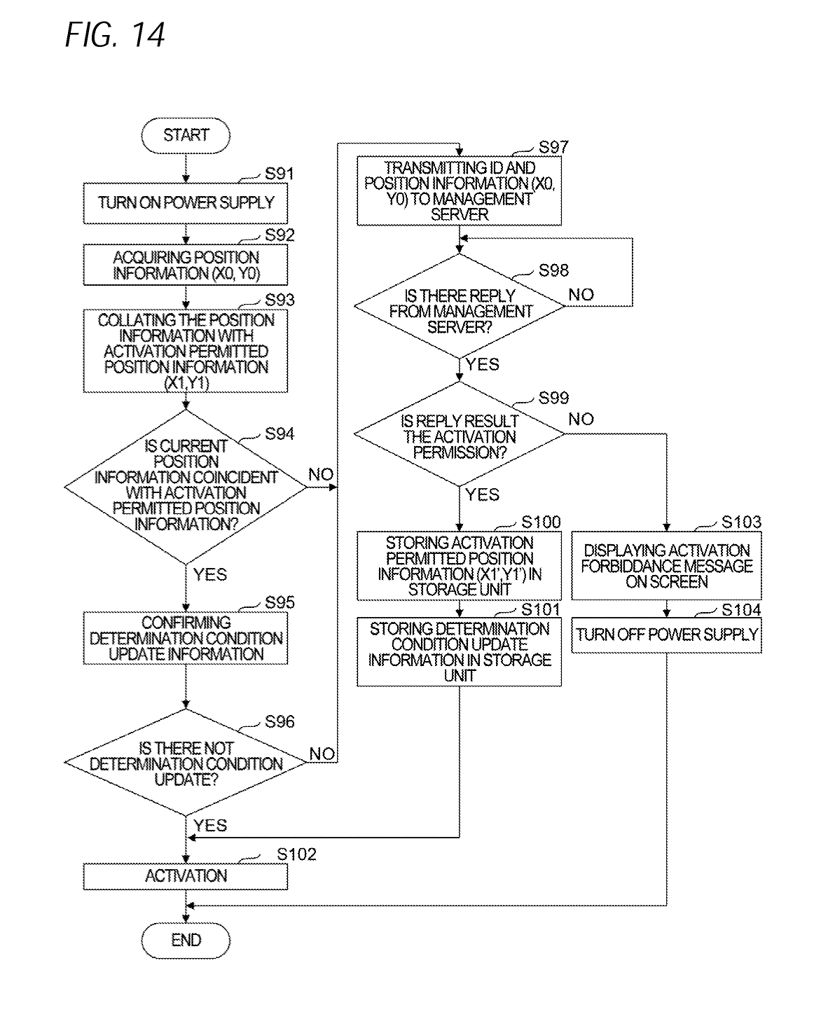

A fourth embodiment of the activation authentication process in the user terminal 11 will be described using a flowchart. FIG. 14 is a flowchart illustrating the fourth embodiment of the activation authentication process in the user terminal.

When being compared with the respective embodiments described above, in the fourth embodiment where the activation management table is updated by the management server 12, the updated information is also reflected in the activation determination condition stored in the user terminal 11 and thus, the activation authentication is performed with the latest determination condition.

In the fourth embodiment to be described below, similar to the first embodiment described above, the activation authentication is performed using the activation permitted position information, but is not limited thereto. For example, the activation authentication may be performed as illustrated in the fourth embodiment based on the position information as described in the second embodiment. Further, the activation authentication may be performed by further including the activation permitted time in the fourth embodiment as described in the third embodiment.

In the example of FIG. 14, when it is detected that the power supply of the user terminal 11 is turned ON by the user (S91), the position information acquisition unit 24 acquires the current position information (X0,Y0) as described above (S92). Subsequently, the authentication unit 25 determines whether the acquired current position information is coincident with the activation permitted position information (X1,Y1) using the acquired current position information and the activation permitted position information stored in the storage unit 23 (S94). In the meantime, the current position information is considered as being coincided with the activation permitted position information when the current position information is completely coincident with the activation permitted position information and when the current position information falls within a predetermined allowable range in the process of S94, similarly to the first embodiment as described above. Here, when the current position information is coincident with the activation permitted position information (“YES” at step S94), the authentication unit 25 subsequently confirms the determination condition update information included in the activation determination condition (S95) and determines whether the determination condition is updated (S96).

Here, in the process of S94 described above, when it is determined that the current position information is not coincident with the activation permission (“NO” at step S94), the activation inquiring unit 26 transmits the identification information (ID) and the current position information (X0,Y0) of the user terminal 11 to the management server 12 (S97). Further, in the process of S96 described above, when it is determined that the determination condition is updated (“NO” at step S96), the activation inquiring unit 26 also transmits the ID and the current position information to the management server 12 (S97). That is, in the process of S97, the user terminal 11 inquires the management server 12 as to whether the activation is allowable as described above.

Subsequently, the activation inquiring unit 26 determines whether a reply has been sent from the management server 12 (S98). When it is determined that the reply has not been sent from the management server 12 (“NO” at step S98), the unit 26 waits until the reply is received. Further, when it is determined that the reply has been sent from the management server 12 (“YES” at step S98), the activation inquiring unit 26 determines whether the reply result is the activation permission (S99).

When it is determined that the reply result is the activation permission (“YES” at step S99), the activation inquiring unit 26 stores the activation permitted position information (X1′,Y1′) included in the activation determination condition transmitted from the management server 12 in the storage unit 23 to update the activation determination condition (S100). Accordingly, the activation permitted position information (X1′,Y1′) becomes the activation determination condition (activation permitted position information (X1,Y1)) in the process of S93 at the time of the next activation authentication. Further, the activation inquiring unit 26 stores the activation determination condition update information obtained from the management server 12 in the storage unit 23 to update the determination condition update information (S101). Further, in the process of S96, when it is determined that the determination condition is not updated (“YES” at step S96), or after completion of the process of step S101, the activation unit 27 activates the user terminal 11 (S102).

When it is determined that the reply result from the management server 12 is not the activation permission in the process of step S99 (“NO” at step S99), the activation inquiring unit 26 displays a message indicative of activation forbiddance on a monitor screen (S103). In the meantime, the message indicative of activation forbiddance may be a message indicating that activation is not allowable due to an authentication error, but is not limited thereto. Further, the activation inquiring unit 26 turns OFF the power supply of the user terminal 11 (S104). The activation inquiring unit 26 may turns OFF the power supply without performing the process of step S103 as described above in the activation authentication.

### <Activation Authentication Process in Management Server 12>

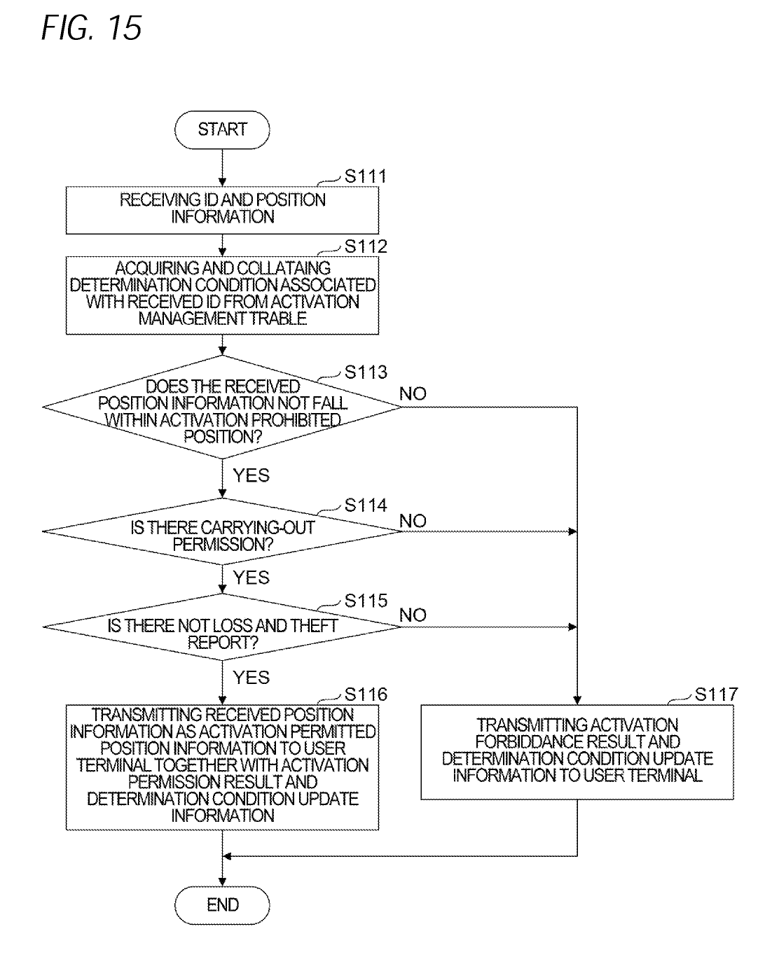

A fourth embodiment of the activation authentication process in the manager server 12 for the fourth embodiment of the activation authentication process in the user terminal 11 as described above will be described using a flowchart. FIG. 15 is a flowchart illustrating the fourth embodiment of the activation authentication process in the management server.

In the example of FIG. 15, registration of various information into the determination condition (for example, an activation management table) associated with each user terminal 11 stored in the storage unit 43 is performed as a maintenance work for the activation management in the management server 12. In the meantime, examples of various information include “activation prohibited range information”, “presence/absence of carrying-out permission”, “presence/absence of a loss/theft report” and “presence/absence of determination condition update”, but are not limited thereto.

That is, in the fourth embodiment, the “presence/absence of determination condition update” for the updated user terminal 11 is set as “presence” in the activation management table as described above, and the determination condition update information is transmitted to the target user terminal 11.

In the example of FIG. 15, the collation unit 45 receives, for example, an identification information (ID) identifying the user terminal 11 and the current position information of the user terminal 11 as information for an inquiry whether activation is allowable from the user terminal 11 (S111). Subsequently, the collation unit 45 acquires the determination condition associated with the received ID from the activation management table stored in the storage unit 43 and performs collation based on a predetermined determination condition (S112).

In the fourth embodiment illustrated in FIG. 15, for example, the position information is collated with the activation prohibited position information included in the determination condition, but is not limited thereto. For example, in the fourth embodiment, when the activation permitted position information is stored in the activation management table, the stored activation permitted position information may be collated with the position information.

The collation unit 45 determines whether the position information received in the process at step S111 does not fall within the activation prohibited position from the result of the collation process of step S112 (S113). When it is determined that the received position information does not fall within the activation prohibited position (“YES” at step S113), the collation unit 45 subsequently determines whether the carrying-out permission for the user terminal 11 is present (S114).

When it is determined that the carrying-out permission is present (“YES” at step S114), the collation unit 45 subsequently determines whether the loss/theft report is not present (S115). Here, when it is determined that the loss/theft report is not present (“YES” at step S115), the activation determination condition generation unit 46 sets the received position information as the activation permitted position information, and transmits the activation permitted position information to the user terminal 11 together with the result of the activation permission and the determination condition update information included in the activation management table (S116).

When it is determined that the received position information falls within the activation prohibited position in the process of step S113 (“NO” at step S113), the collation unit 45 transmits the result of the activation forbiddance to the user terminal 11 (S117). In the meantime, when it is determined that that the carrying-out permission is not present in the process of step S114 (“NO” at step S114) or the loss/theft report is present in the process of step S115 (“NO” at step S115), the collation unit 45 transmits the result of the activation forbiddance to the user terminal 11 as described above (S117).

Here, at least one process among the processes of steps S113, S114, and S115 described above may be executed to perform the activation authentication. Further, the process sequence of steps S113, S114, and S115 is not limited to the example illustrated in FIG. 15, but may be arbitrarily modified.

### <Example of Data Associated>

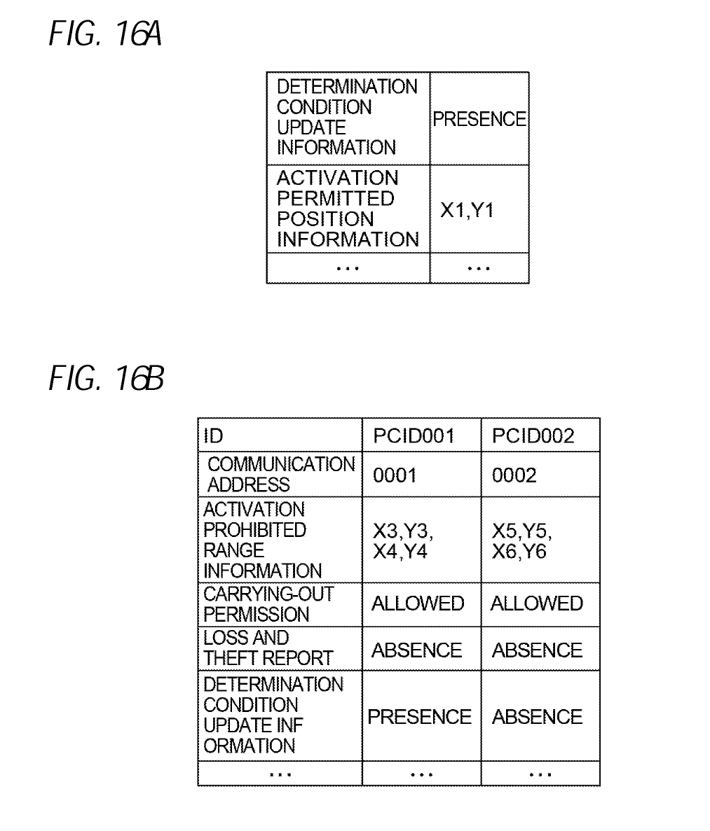

FIGS. 16A and 16B are views illustrating an example of data associated with the fourth embodiment. FIG. 16A illustrates an example of the activation determination condition table stored in the user terminal 11 and FIG. 16B illustrates an example of the activation management table stored in the management server 12.

The activation determination condition table illustrated in FIG. 16A includes, for example, “determination condition update information” and “activation permitted position information” as items, but is not limited thereto. Further, the activation management table illustrated in FIG. 16B includes, for example, “ID”, “communication address”, “activation prohibited position information”, and “carrying-out permission”, “loss/theft report” and “determination condition update information”, but is not limited thereto.

In the fourth embodiment, the presence/absence of the determination condition update is set as the “determination condition update information” in the activation determination condition table illustrated in FIG. 16A and the activation management table illustrated in FIG. 16B. Here, for example, in a case where the determination condition update is set as “presence”, even when the activation determination condition table is present in the storage unit 23 of the user terminal 11 and the activation permitted position information included in the activation determination condition table is coincident with the current position information, the user terminal 11 inquires the management server 12 as to whether the activation is allowable. Further, in a case where the determination condition update is set as “absence”, when the activation permitted position information included in the activation determination condition table is coincident with the current position information, the user terminal 11 performs authentication to activate without inquiring the management server 12 as to whether the activation is allowable.

Accordingly, collation may be performed using latest activation determination condition and thus, the activation authentication may be performed appropriately in the fourth embodiment. Accordingly, in the fourth embodiment, when the loss/theft report is made even after the user terminal 11 is stolen, it is possible to prevent the user terminal 11 from being used illegally by a person who has stolen the user terminal.

In the fourth embodiment, in a case of the activation permission, the management server 12 sets the current position information sent from the user terminal 11 as the activation permitted position information and transmits the current position information to the user terminal 11 together with a determination result of the activation permission and the determination condition update information. The user terminal 11 stores, for example, the activation permitted position information or the determination condition update information in the activation determination condition table as illustrated in FIG. 16A.

In the meantime, appropriate combination of plural embodiments among the first to the fourth embodiments as described above may also obtain similar effects. Accordingly, in the present embodiment, the activation may be performed using the current position information, the activation permitted position information and the activation permitted range information at the time of the activation authentication. Further, the activation authentication may be performed by including, for example, the activation permitted time or the number of times that activation may be performed in the determination condition.

According to the embodiments described above, when a place where the user terminal is located is the place for which the management server has authenticated, communication with the management server may not be needed at the time of the next activation of the user terminal and thus, communication traffic may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal device comprising:
a storage unit configured to store an activation determination condition; and
a control unit configured to execute a procedure, including:
acquiring first position information for indicating an area where the terminal device is located;
authenticating an activation based on the activation determination condition stored in the storage unit and the first position information; and
inquiring of an information processing apparatus coupled through a communication network as to whether activation is allowable when an authentication result of the authenticating of activation is an activation forbiddance.

2. The terminal device according to claim 1, wherein the authenticating of activation permits activation when second position information included in the activation determination condition is coincident with the first position information, the second position information indicating an area where the activation is permitted.

3. The terminal device according to claim 1, wherein the inquiring inquires of the information processing apparatus based on the first position information to receive the second position information from the information processing apparatus and updates the activation determination condition with the received second position information.

4. The terminal device according to claim 1, wherein the authenticating of activation collates information of an activation permitted range included in the activation determination condition with the first position information, and permits the activation when the area indicated by the first position information is settled within the activation permitted range.

5. The terminal device according to claim 1, wherein the authenticating of activation compares an activation permitted time included in the activation determination condition and a current time, and permits the activation when the current time is settled within the activation permitted time.

6. The terminal device according to claim 1, wherein the authenticating of activation determines whether the determination condition included in the activation determination condition is updated, and inquires of the information processing apparatus as to whether activation is allowable when the determination condition is updated.

7. The terminal device according to claim 1, wherein the inquiring updates contents of the activation determination condition stored in the storage unit based on contents of the activation determination condition obtained from the information processing apparatus.

8. An information processing apparatus comprising:
a storage unit in which a procedure is stored; and
a control unit configured to execute the procedure, including:
setting a determination condition as to whether activation is allowable for a terminal device;
collating a determination condition associated with the terminal device with respect to inquiry from the terminal device as to whether activation is allowable with position information of the terminal device acquired at a time of the inquiry to determine whether the activation of the terminal device is allowable, the position information indicating an area where the terminal device is located; and
generating an activation determination condition to be stored in the terminal device when the activation of the terminal device is permitted.

9. The information processing apparatus according to claim 8, wherein the generating determines whether the determination condition included in the activation determination condition is updated.

10. An activation authentication method executed by an activation authentication system including a terminal device and an information processing apparatus, the activation authentication method comprising:
acquiring position information for indicating an area where the terminal device is located, by the terminal device;
authenticating an activation of the terminal device based on an activation determination condition stored in a storage unit in advance and the position information, by the terminal device;
inquiring of the information processing apparatus coupled through a communication network as to whether activation is allowable when an authentication result of the authenticating of the activation is an activation forbiddance, by the terminal device;
receiving the inquiry from the terminal device as to the activation, by the information processing apparatus;
acquiring the position information acquired at a time of the inquiry, by the information processing apparatus;
extracting a determination condition corresponding to the terminal device, by the information processing apparatus;
collating the determination condition with the position information to determine whether the activation of the terminal device is allowable, by the information processing apparatus; and
generating the activation determination condition to be stored in the terminal device when the activation of the terminal device is permitted, by the information processing apparatus.
